(19) United States
(12) Patent Application Publication
(10) Pub. No.: US 2015/0382053 A1
(43) Pub. Date: Dec. 31, 2015

(54) METHOD, ELECTRONIC DEVICE, AND COMPUTER PROGRAM PRODUCT

(71) Applicant: Kabushiki Kaisha Toshiba, Tokyo (JP)

(72) Inventors: Tomonori SAKAGUCHI, Ome Tokyo (JP); Masahiko OJIMA, Ome Tokyo (JP); Shinichiro MANABE, Akishima Tokyo (JP); Mitsuru SHIMBAYASHI, Nakano Tokyo (JP); Takuya KODA, Hino Tokyo (JP)

(21) Appl. No.: 14/843,902

(22) Filed: Sep. 2, 2015

Related U.S. Application Data
(63) Continuation of application No. PCT/JP2013/076350, filed on Sep. 27, 2013.

(51) Int. Cl. H04N 21/431; H04N 21/482; H04N 5/445; H04N 21/414

(52) U.S. Cl. CPC H04N 21/4312; H04N 21/41407; H04N 21/4821; H04N 21/4314; H04N 5/44543; H04N 2005/44556

(57) ABSTRACT

According to one embodiment, a method includes: accessing program information identifying a broadcast start time and a broadcast time period of each of a plurality of broadcast programs; displaying a first bar of a first length and a first mark on a display based on the program information, the first length corresponding to a first broadcast time period of a first broadcast program; displaying a second bar of a second length and a second mark on the display based on the program information, the second length corresponding to a second broadcast time period of a second broadcast program; and displaying, when the first broadcast time period and the second broadcast time period are different from each other, the first bar and the second bar on the display such that the first length and the second length are different from each other.

### CROSS-REFERENCE TO RELATED APPLICATIONS

This application is a continuation of International Application No. PCT/JP2013/076350, filed on Sep. 27, 2013, the entire contents of which are incorporated herein by reference.

### FIELD

Embodiments described herein relate generally to a method, an electronic device, and a computer program product.

### BACKGROUND

Conventionally, there has been known a technology for for displaying information on, for example, a broadcast start time time of a broadcast program and the current time. In this technology, the information on the broadcast start time of the broadcast program and the current time are displayed at separate positions.

In the above technology, it is difficult to visually understand the relationship between the broadcast start time and the broadcast end time of a broadcast program and the current time, such as the length of time elapsed since a broadcast of a TV program has been started or the remaining time before a broadcast of a TV program ends.

### BRIEF DESCRIPTION OF DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating an example of a configuration of a video recording/playback system according to an embodiment;

FIG. 2 is an exemplary block diagram illustrating an example of a hardware configuration of a mobile terminal in the embodiment;

FIG. 3 is an exemplary block diagram illustrating an example of a functional configuration of the mobile terminal and a digital television device in the embodiment;

FIG. 4 is an exemplary diagram illustrating an example of metadata corresponding to program schedule data in the embodiment;

FIG. 5 is an exemplary diagram illustrating an example of a current program schedule displayed on a display module of the mobile terminal in the embodiment;

FIG. 6 is an exemplary diagram illustrating an example of a current program schedule displayed, in a mode different from that illustrated in FIG. 5, on the display module of the mobile terminal in the embodiment;

FIG. 7 is an exemplary diagram illustrating an example of a past program schedule displayed on the display module of the mobile terminal in the embodiment;

FIG. 8 is an exemplary diagram illustrating an example of a menu bar displayed on the display module of the mobile terminal in the embodiment;

FIG. 9 is an exemplary diagram illustrating an example of a voice input screen displayed on the display module of the mobile terminal in the embodiment;

FIG. 10 is a flowchart illustrating the processing performed by a CPU when the current program schedule is displayed on the display module of the mobile terminal in the embodiment; and

FIG. 11 is an exemplary diagram illustrating an example of a current program schedule displayed on a display module of a mobile terminal according to a modification of the embodiment.

### DETAILED DESCRIPTION

In general, according to one embodiment, a method comprises: accessing program information identifying a broadcast start time and a broadcast time period of each of a plurality of broadcast programs; displaying a first bar of a first length and a first mark on a display based on the program information, the first length corresponding to a first broadcast time period of a first broadcast program, the first mark on the first bar identifying a current time; displaying a second bar of a second length and a second mark on the display based on the program information, the second length corresponding to a second broadcast time period of a second broadcast program, the second mark on the second bar identifying the current time; and displaying, when the first broadcast time period and the second broadcast time period are different from each other, the first bar and the second bar on the display such that the first length and the second length are different from each other.

An Embodiment will be described below based on the drawings.

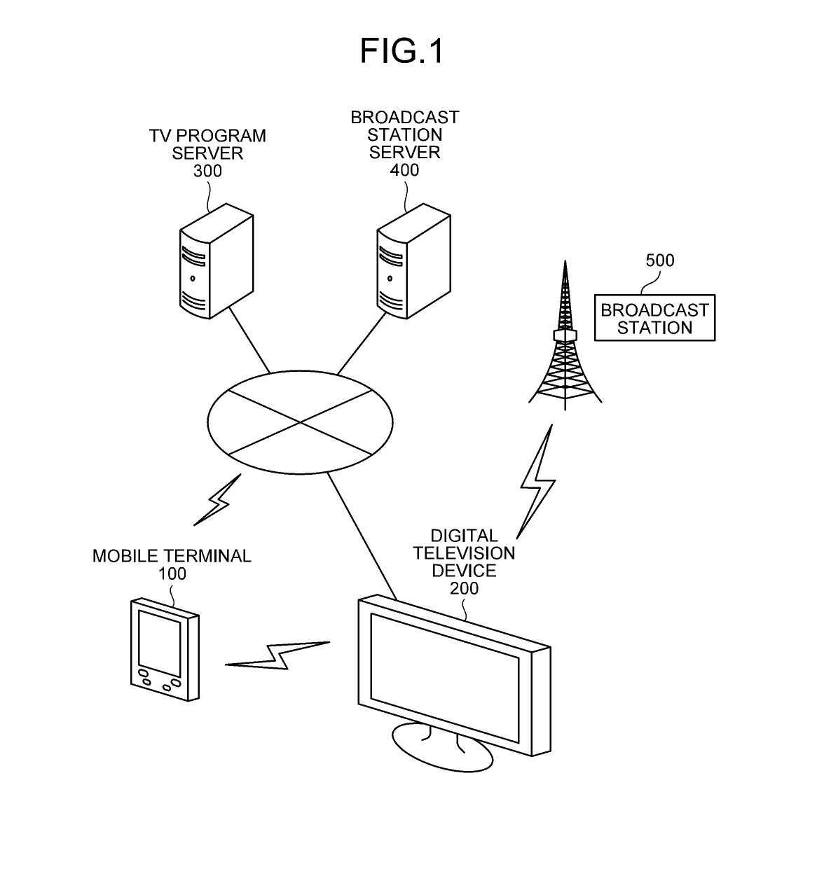

First, an example of a configuration of a video recording/playback system according to an embodiment will be described with reference to FIGS. 1 to 9. As illustrated in FIG. 1, the video recording/playback system comprises a mobile terminal 100 and a digital television device 200 which are connected to each other via a wireless network, such as a Wifi (registered trademark) or the like. Furthermore, the mobile terminal 100 and the digital television device 200 are connected to a TV program server 300 served by a service vendor on the Internet, a broadcast station server 400, or the like. Furthermore, the digital television device 200 is configured to receive broadcast waves sent from a broadcast station 500.

The digital television device 200 comprises a tuner to receive signals of digital broadcasting and has a video recording/playback function for broadcast programs. Furthermore, the digital television device 200 has a Web browsing function to search the Internet for various sites and to display the sites. Furthermore, the digital television device 200 includes applications for Hybridcast (registered trademark). Namely, the digital television device 200 is configured to receive broadcast waves from the broadcast station 500 and to receive content or applications related to broadcast programs from the broadcast station server 400 or the TV program server 300, thus displaying content cooperating with a broadcast program together with a broadcast program.

In the embodiment, a description will be given of an example of a case in which the digital television device 200 is used as a video recording/playback device; however, another device other than the digital television device 200 may also be used as long as the device has a video recording/playback function. Namely, a device, such as a hard disc recorder, a set-top box, or the like that processes video images and that outputs the video images to an externally-connected display device may be used as long as the device includes a tuner that receives broadcast waves and that has the video recording/playback function.

The mobile terminal 100 is an electronic device that functions as a remote controller to perform an operation with respect to the digital television device 200. Namely, in the mobile terminal 100, a predetermined application program that allows the mobile terminal 100 to function as the remote controller with respect to the digital television device 200 is installed. In the embodiment, the mobile terminal 100 is implemented as a cellular phone, such as a smartphone, a tablet terminal, a slate terminal, or the like.

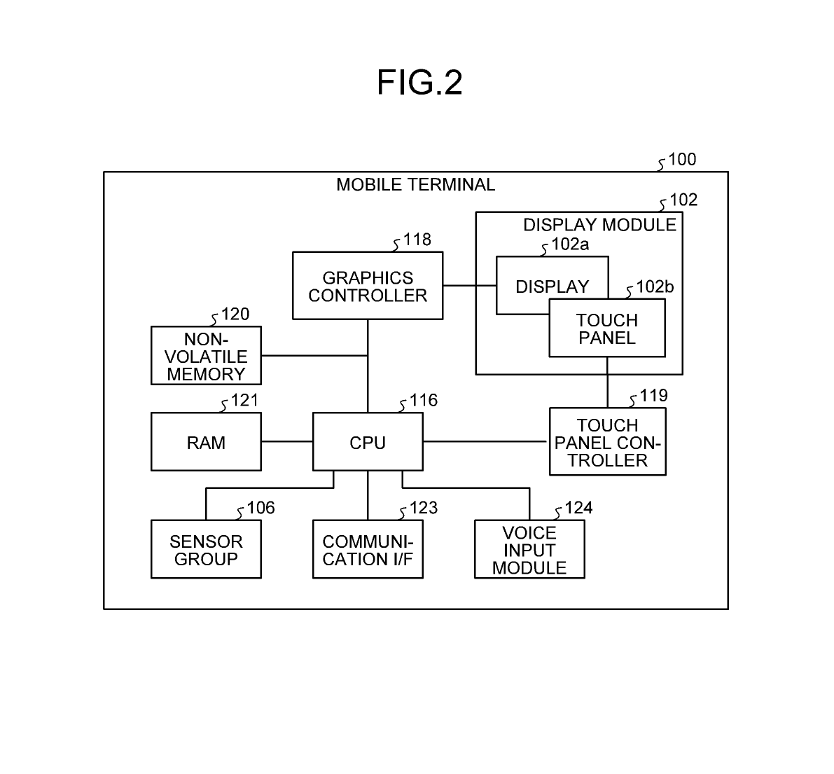

As illustrated in FIG. 2, the mobile terminal 100 comprises a display module 102, a central processing unit (CPU) 116, a graphics controller 118, a touch panel controller 119, a nonvolatile memory 120, a random access memory (RAM) 121, a communication interface (I/F) 123, a sensor group 106, and a voice input module 124. Furthermore, in the embodiment, in addition to the above, the mobile terminal 100 may also comprise a camera, a speaker, or the like.

The voice input module 124 is a voice input device, such as a microphone, and is configured to receive a voice output from a user as an input. In the embodiment, the voice input module 124 receives, via the user's voice, an input text described in a natural language that is used to implement an operation performed on the digital television device 200.

The display module 102 is configured as a so-called touch screen that is a combination of a display 102a and a touch panel 102b. The display 102a is, for example, a liquid crystal display (LCD), an organic electro luminescence (EL) display, or the like. The touch panel 102b detects a position (touch position) on a display screen of the display 102a touched by a user's finger, a stylus pen, or the like.

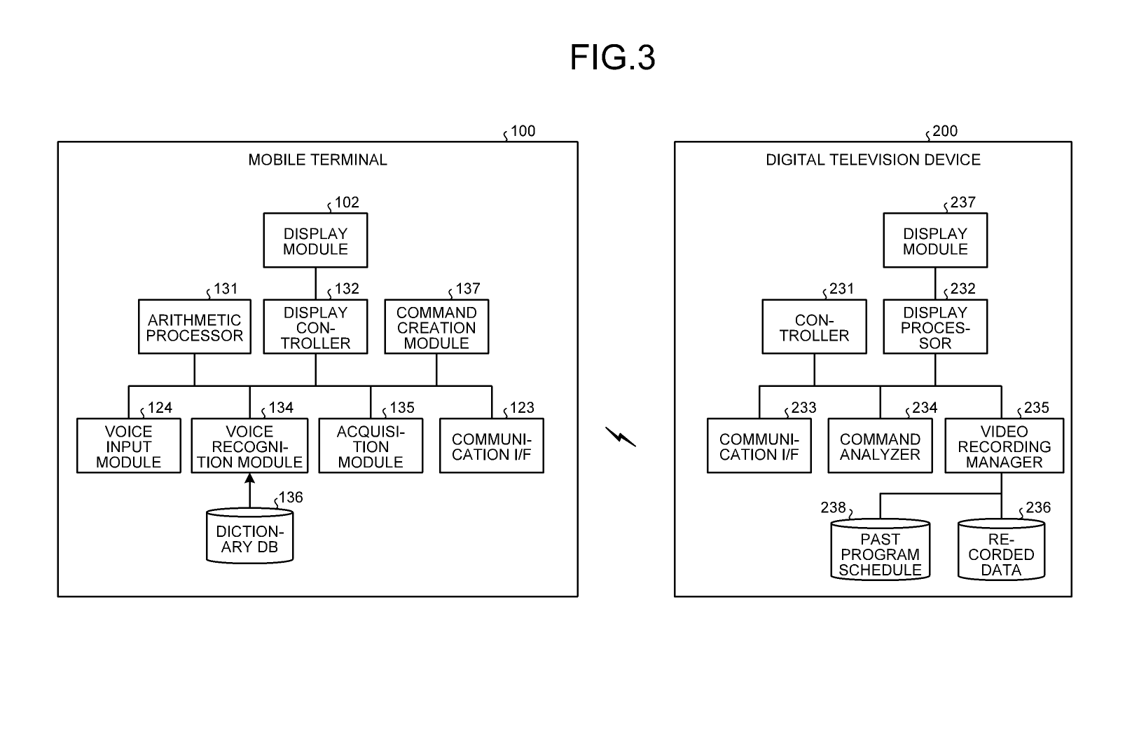

The nonvolatile memory 120 stores therein an operation system, various application programs, various kinds of data needed to perform the programs, or the like. The CPU 116 is a hardware processor configured to control an operation of the mobile terminal 100 and to control each of the components in the mobile terminal 100. By performing various application programs (the operating system, various applications, or the like) loaded in the RAM 121 from the nonvolatile memory 120, the CPU 116 implements each of the functional modules illustrated in FIG. 3, which will be described later. The RAM 121 provides, as the main memory of the mobile terminal 100, a work area when the CPU 116 executes a program.

The graphics controller 118 is a display controller configured to control the display 102a in the display module 102. The touch panel controller 119 is configured to control the touch panel 102b and to acquire, from the touch panel 102b, coordinate data indicating a touch position on the display screen touched by a user.

The communication I/F 123 is configured to perform, under the control of the CPU 116, wireless communication with an external device such as the digital television device 200 or the like, or communication via a network such as the Internet or the like.

The sensor group 106 is, for example, an acceleration sensor configured to detect a direction and a magnitude of external acceleration with respect to the mobile terminal 100, an orientation sensor configured to detect an orientation of the mobile terminal 100, a gyro sensor configured to detect an angular velocity (rotation angle) of the mobile terminal 100, or the like.

The mobile terminal 100 implements each of the functional modules illustrated in FIG. 3 by working in cooperation with the CPU 116 and various application programs (the operating system, a command creating application, or the like) stored in the nonvolatile memory 120.

As illustrated in FIG. 3, the mobile terminal 100 comprises, as a functional configuration, an arithmetic processor 131, a display controller 132, a voice recognition module 134, an acquisition module 135, a dictionary database (DB) 136, and a command creation module 137. The acquisition module 135 is an example of a “program receiver”. For convenience of explanation, in addition to these functional modules, FIG. 3 also illustrates the hardware configuration, such as the display module 102, the communication I/F 123, and the voice input module 124, which have been described above.

The dictionary DB 136 is a database in which various kinds of words are registered and is referred to when a voice recognition process is performed by the voice recognition module 134. The dictionary DB 136 is stored in a storage medium, such as a hard disk drive (HDD), a memory, or the like. In the embodiment, a description will be given of a case in which, by providing the dictionary DB 136 in the mobile terminal 100, the voice recognition process is performed on the mobile terminal 100 side; however, the voice recognition process may also be performed on the TV program server 300 side by installing the dictionary DB 136 in the TV program server 300.

The arithmetic processor 131 is configured to perform various kinds of arithmetic processing to control each component of the mobile terminal 100. The voice recognition module 134 is configured to perform, by using the dictionary DB 136, a voice recognition processing or a morphological analysis processing on voice data on an input text described in a natural language that was input to the voice input module 124, and to output character strings as the result of the voice recognition.

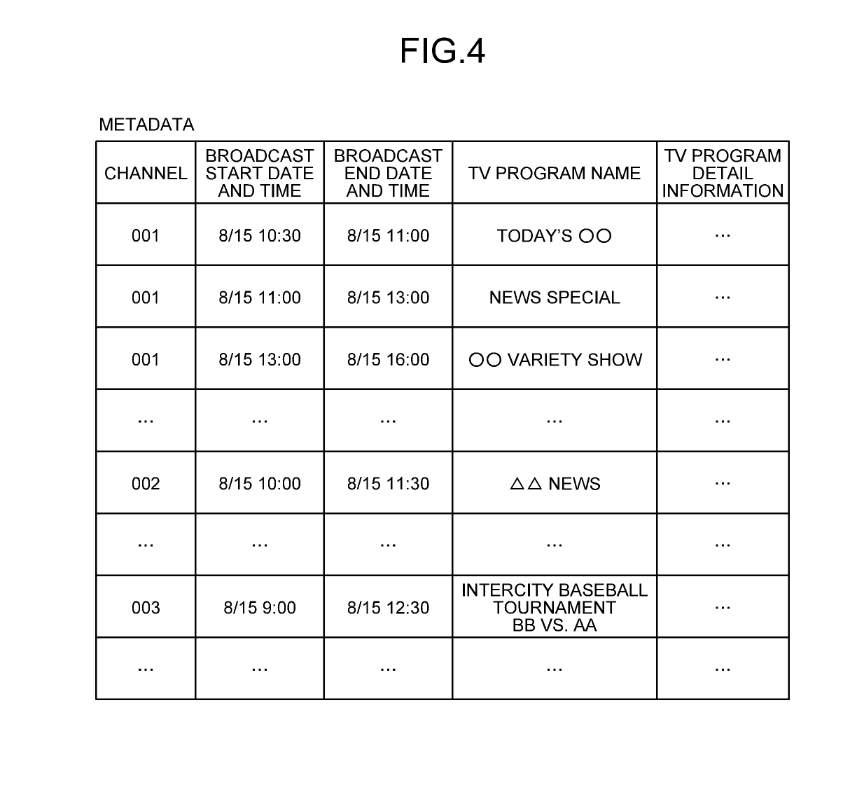

The acquisition module 135 is configured to access the TV program server 300, the digital television device 200 or the like to acquire TV program information (hereinafter, referred to as program schedule data) capable of identifying the broadcast start time and the broadcast time period of a broadcast program. More specifically, the acquisition module 135 is configured to acquire, from the TV program server 300, a TV program schedule (for example, Electronic Program Guide (EPG), etc.) that is a list of TV programs to be broadcast from now and includes a list of TV programs (hereinafter, referred to as current programs) being currently broadcast. Furthermore, the acquisition module 135 is configured to acquire, from the digital television device 200, a list (past program schedule 238 to be described later) of the TV programs recorded in the digital television device 200 in the past. Here, the program schedule data is configured by metadata illustrated in FIG. 4.

As illustrated in FIG. 4, as an example, a plurality sets of items of a channel, a broadcast start date and time, a broadcast end date and time, a TV program name, TV program detail information (information on performers or the like in a TV program) are registered in the metadata in an associated manner. For example, if it is assumed that the metadata illustrated in FIG. 4 is acquired from the TV program server 300, it is found that, from the metadata illustrated in FIG. 4, the TV program titled “today's 00” is broadcast from 10:30 to 11:00 on August 15 on a channel 001, and it is found that the TV program titled “news special” is broadcast from 11:00 to 13:00 on August 15 on the channel 001. Furthermore, if it is assumed that the metadata illustrated in FIG. 4 is acquired from the digital television device 200, it is found that, from the metadata illustrated in FIG. 4, the TV program titled “today's 00” that was broadcast from 10:30 to 11:00 on August 15 on a channel 001 has already been recorded in the digital television device 200, and it is found that the TV program titled “news special” that was broadcast from 11:00 to 13:00 on August 15 on the channel 001 has already been recorded in the digital television device 200. Meanwhile, a plurality of channels is registered in the metadata illustrated in FIG. 4; however, these channels can be freely changed by a setting performed by a user.

The display controller 132 is configured to control an input/output with respect to the display module 102. Namely, the display controller 132 is configured to control, via the graphics controller 118, a display screen that is output to the display 102a in the display module 102 and to control, via the touch panel controller 119, an input received from the touch panel 102b in the display module 102 triggered by a touch operation performed by a user.

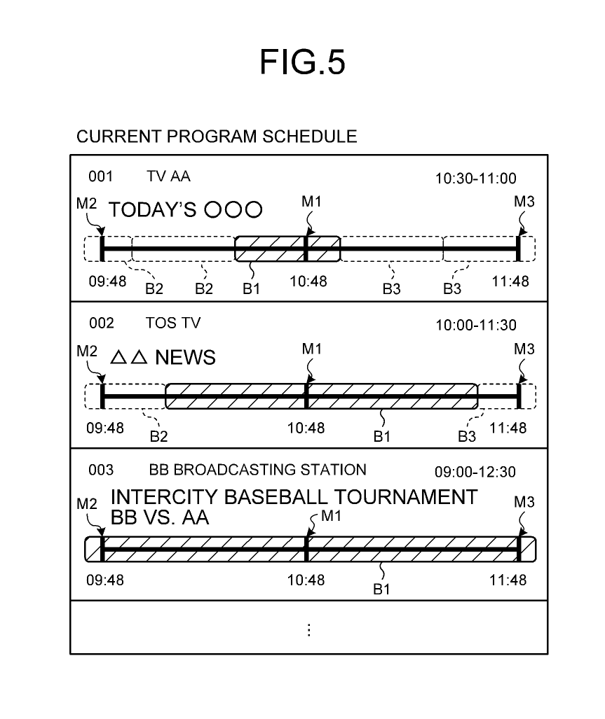

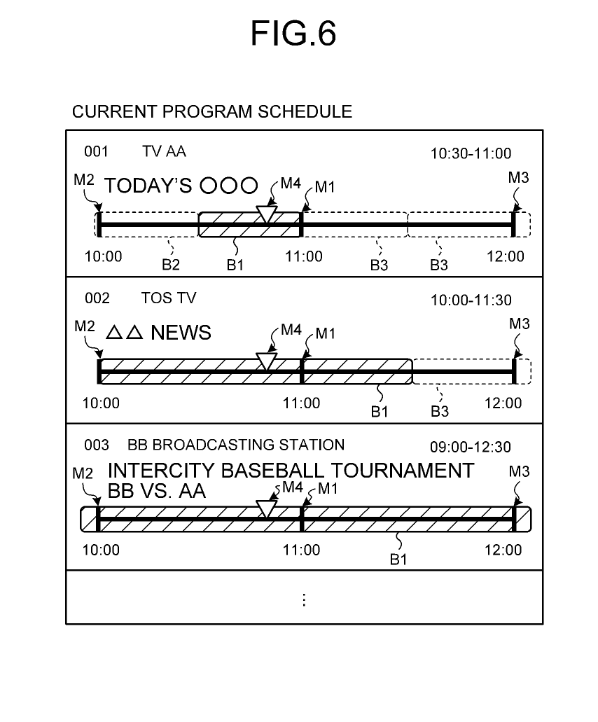

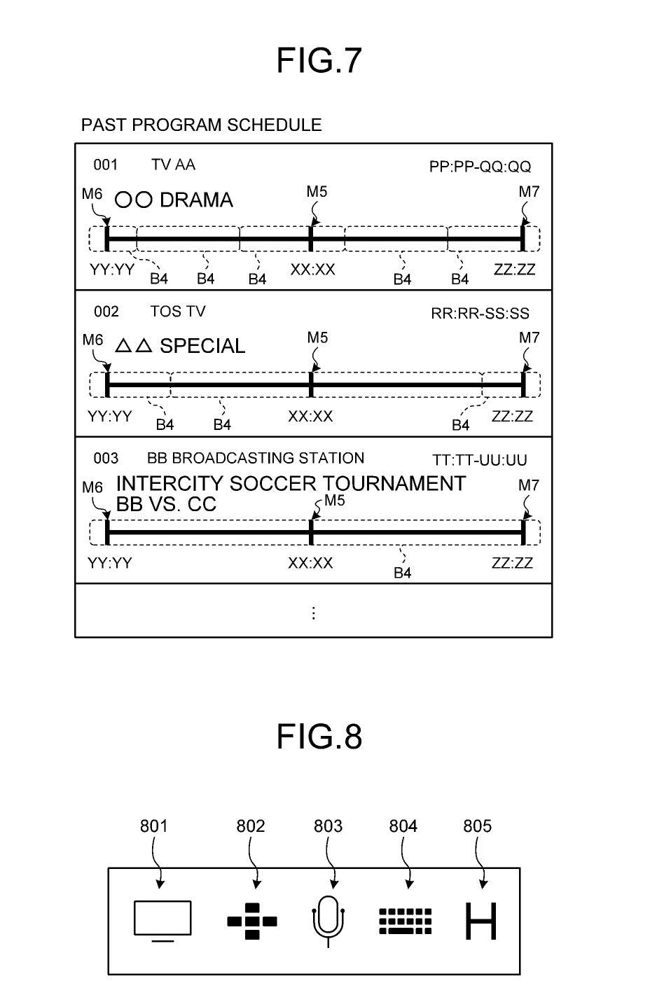

Here, in the embodiment, when program schedule data is acquired by the acquisition module 135, the display controller 132 is configured to display the current program schedules illustrated in FIGS. 5 and 6 or the past program schedule illustrated in FIG. 7 on the display module 102 based on the acquired program schedule data. The display of these current program schedules and the past program schedule ends when an end instruction is received from the user.

First, the current program schedule illustrated in FIG. 5 will be described. This current program schedule is displayed when the acquisition module 135 acquires the program schedule data from the TV program server 300 triggered when a touch operation or a voice input operation is performed by a user.

The current program schedule illustrated in FIG. 5 displays thereon straight lines each extending from in the horizontal direction and each having three scales M1 to M3, and a plurality of bars B1 to B3 positioned on each of the straight lines. Furthermore, the current program schedule displays thereon information (a channel number, channel name, or the like) related to the plurality of channels included in the program schedule data acquired from the TV program server 300, information (the TV program name, the broadcast start time and the broadcast end time) of the current programs indicated by the bars B1, and the like. The scales M1 to M3, bars B1 to B3, and the various kinds of information is separately displayed for each channel registered in the metadata.

Each of the scales M1 functions as a mark configured to indicate the reference time that is the reference when the bars B1 to B3 are displayed. In the example illustrated in FIG. 5, the current time (10:48) is displayed below each of the scales M1 as the reference time. Each of the scales M2 functions as a mark configured to indicate a first time earlier than the reference time by a predetermined time. In the example illustrated in FIG. 5, time (9:48) that is one hour before the current time is displayed as the first time below each of the scales M2. Each of the scales M3 functions as a mark configured to indicate a second time later than the reference time by the predetermined time. In the example illustrated in FIG. 5, time (11:48) that is one hour after the current time is displayed as the second time below each of the scales M3.

Each of the bars B1 has a length corresponding to the broadcast time period of a current program that is currently being broadcast. Furthermore, each of the bars B1 is displayed so as to overlap with each of the scales M1 as the mark that indicates the current time. With this, by looking at the bars B1 and the scales M1, it is possible to visually recognize the time elapsed since the broadcast of each of the current programs has been started or the remaining time before the broadcast of each of the current programs ends. In the example illustrated in FIG. 5, each of the bars B1 is displayed as a rounded rectangle bar with oblique-line hatching indicated by the solid line. Furthermore, the bar B1 is an example of a “third bar”.

Each of the bars B2 has a length corresponding to the broadcast time period of an immediately previous TV program that was broadcast immediately before the current program. Each of the bars B3 has a length corresponding to the broadcast time period of an immediately subsequent TV program that is to be broadcast immediately after the current program. These bars B2 and B3 are displayed on the straight line together with the bar B1 described above. Furthermore, the bars B2 and B3 are displayed in a display mode that is different from the display mode of the bar B1. In the example illustrated in FIG. 5, the bars B2 and B3 are displayed as the rounded rectangle bars indicated by the dotted line without hatching. The bars B2 and B3 are examples of a “fourth bar” and a “fifth bar”, respectively.

In the example illustrated in FIG. 5, as the time has elapsed, the current time displayed below each of the scales M1 at the center and the time displayed below each of the other scales M2 and M3 are changed and, accordingly, the display positions of each of the combinations of the bars B1 to B3 move in the horizontal direction (basically, to the left). Meanwhile, in the example illustrated in FIG. 5, by performing a flick operation (a sliding operation, by a finger, on the area in which the bars B1 to B3 are displayed while touching the area) on the area in which the bars B1 to B3 are displayed, a user can freely move the display positions of the bars B1 to B3 in the horizontal direction.

In the following, the current program schedule displayed in a mode that is different from the mode illustrated in FIG. 5 will be described with reference to FIG. 6. In the example illustrated in FIG. 6, unlike the example illustrated in FIG. 5 in which the reference time is the current time, the reference time is the time that is the closest to the current time from among a plurality of times provided at constant time intervals.

Namely, in the current program schedule illustrated in FIG. 6, each of the scales M1 that is positioned at the center and used as the reference to display the bars B1 to B3 indicates time (11:00) that is the closest to the current time (10:48) from among the fixed times (1:00, 2:00, . . . , 11:00, and 12:00) at time intervals of one hour. Then, the current time is identified by a mark M4 having an inverted triangle displayed on the straight line that extends in the horizontal direction and that has the scales M1 to M3.

In the example illustrated in FIG. 6, as the time has elapsed, the display position of each of the marks M4 that indicates the current time moves in the horizontal direction (basically, to the right). Then, if the display position of the mark M4 moves from the position corresponding to the bar B1 indicating the current program to the position corresponding the bar B2 indicating the immediate subsequent TV program, the bar that was being displayed as the bar B1 up to that time is displayed as the bar B3 indicating the immediate previous TV program and the bar that was being displayed as the bar B2 up to that time is displayed as the bar B1 indicating the current program.

Here, in the example illustrated in FIG. 6, the display positions of the bars B1 to B3 are not basically changed. However, in the example illustrated in FIG. 6, when the mark M4 that indicates the current time moves to the position closer to the scale M3 that is located on the right side, the reference time identified by the scale M1 at the center is switched to the immediately subsequent time and, accordingly, the display positions of the bars B1 to B3 are changed. For example, if it is assumed that the reference time is 11:00 up to that time, when the mark M4 moves to the position closer to the scale M3 located on the right side, the reference time is changed to 12:00. Then, if the reference time is changed in this way, the display positions of the bars B1 to B3 move toward the left side in accordance with this change. The timing at which the reference time is changed is the time at which, for example, the mark M4 indicating the current time moves to the position (the position on the right side of the position corresponding to a position at 30 minutes before the second time) closer to the scale M3 indicating the second time than the scale M1 indicating the reference time.

Meanwhile, similarly to the example illustrated in FIG. 5, in the example illustrated in FIG. 6, by performing a flick operation on the area in which the bars B1 to B3 are displayed, a user can freely move the display positions of the bars B1 to B3 in the horizontal direction.

As described above, in the embodiment, if metadata corresponding to the current program schedule is acquired by the acquisition module 135, the display controller 132 displays the bars (the bars B1 to B3 illustrated in FIGS. 5 and 6) each having a length corresponding to the broadcast time period of the broadcast program on the display module 102 based on the acquired metadata, and displays the mark (the scale M1 illustrated in FIG. 5 and the mark M4 illustrated in FIG. 6) indicating the current time on the bar B1 (so as to overlap with the bar B1). Furthermore, the display controller 132 displays the bar B2 and the bar B3 on the display module 102 in a mode that is different from the mode that is used for the bar B1. Here, the bar corresponds to the current time, the bar B2 corresponds to the immediately previous TV program that was broadcast immediately before the current program, and the bar B3 corresponds to the immediately subsequent TV program that is to be broadcast immediately after the current program.

Furthermore, in the embodiment, the display controller 132 displays the bars and the marks described above on the display module 102 within the length corresponding to the time period between the first time that is a predetermined time before the reference time and the second time that is the predetermined time after the reference time. The first time is the time corresponding to each of the scales M2 illustrated in FIGS. 5 and 6 and the second time is the time corresponding to each of the scales M3 illustrated in FIGS. 5 and 6. Furthermore, in the embodiment, as illustrated in FIGS. 5 and 6, if the broadcast start time of the current program, the immediately previous TV program, and the immediately subsequent TV program do not match the first time, each of the left end portions of the bars B1 to B3 corresponding to the broadcast start time is displayed such that each of the left end portions protrudes from the left side of each of the scales M2 corresponding to the first time. Similarly, if the broadcast end time of the current program, the immediately previous TV program, and the immediately subsequent TV program do not match the second time, each of the right end portions of the bars B1 to B3 corresponding to the broadcast end time is displayed such that each of the right end portions protrudes from the right side of each of the scales M3 corresponding to the second time.

Furthermore, in the embodiment, the display controller 132 displays the bars B1, the marks, and the like on the display module 102 for each channel registered in the metadata. Namely, if two broadcast programs that belong to different channels are assumed to be a first broadcast program and a second broadcast program, respectively, the display controller 132 displays a combination of a first bar and a first mark corresponding to the first broadcast program and a combination of a second bar and a second mark corresponding to the second broadcast program on different positions on the display screen of the display module 102. Furthermore, if a first broadcast time period of the first broadcast program is different from a second broadcast time period of the second broadcast program, the display controller 132 displays, on the display module 102, the first bar and the second bar such that a first length of the first bar and a second length of the second bar are different from each other.

Furthermore, in the embodiment, if a portion in which one of the above described bars is displayed on the display screen is touched by a user, the display controller 132 displays, on the display module 102, TV program detail information on the TV program corresponding to the touched bar. Furthermore, a mode of displaying the current program schedule can be freely changed by a user by changing the settings of modes between the mode illustrated in FIG. 5 and the mode illustrated in FIG. 6.

In the following, the past program schedule illustrated in FIG. 7 will be described. This past program schedule is displayed when the acquisition module 135 acquires program schedule data from the digital television device 200 due to a touch operation, a voice input operation, or the like performed by a user, which will be described later. The past program schedule is a program schedule of recorded data that is recorded and stored in an HDD or the like by using a so-called time shift machine function in which broadcast programs on all channels are periodically recorded on the digital television device 200 side. Furthermore, a program schedule of recorded data reserved, recorded, and stored by a user without using the time shift machine function may also be used as a past program schedule.

The past program schedule illustrated in FIG. 7 displays thereon straight lines each extending from in the horizontal direction and each having three scales M5 to M7 and a plurality of bars B4 positioned on each of the straight lines. Furthermore, the past program schedule also displays thereon information related to a plurality of channels included in the program schedule data acquired from the digital television device 200, information (the TV program name, the broadcast start time and the broadcast end time) of each of the past TV programs that were recorded in the past indicated by the bars B4, and the like. The scales M5 to M7, the bars B4, and the various kinds of information is separately displayed for each channel registered in the metadata.

The scale M5 functions as a mark indicating the reference time that is used the reference when the plurality of the bars B4 is displayed. In the example illustrated in FIG. 7, in the lower portion of the scale M5, time represented by XX:XX is displayed as the reference time. The scale M6 functions as a mark that indicates time (in the example illustrated in FIG. 7, time represented by YY:YY) that is a predetermined time before the reference time. The scale M7 functions as a mark indicating time (In the example illustrated in FIG. 7, time represented by ZZ:ZZ) that is a predetermined time after the reference time.

Each of the bars B4 has a length corresponding to the broadcast time period of a past TV program. With this, by looking at the bars B4 and the scale M5 when the past TV program is viewed, it is possible to easily and visually recognize, for example, the remaining viewing time with respect to the reference time. In the example illustrated in FIG. 7, each of the bars B4 is displayed by using a rounded rectangle bar indicated by the dotted line without hatching. Similarly to the examples illustrated in FIG. 5 and FIG. 6, in the example illustrated in FIG. 7, the bars B4 described above are also displayed on the display module 102 for each channel. Furthermore, similarly to the examples illustrated in FIG. 5 and FIG. 6, in the example illustrated in FIG. 7, by performing a flick operation on the area in which the bars B4 are displayed, a user can freely move the display positions of the bars B4 in the horizontal direction. If an area corresponding to one of the bars B4 is touched by a user while the past program schedule is being displayed on the display screen, the display controller 132 displays, on the display module 102, TV program detail information on the TV program corresponding to the touched bar B4. Alternatively, if an area in which one of the bars B4 is displayed is touched by a user, the display controller 132 may also be configured to acquire a preview video image of the TV program corresponding to the touched bar B4 from the digital television device 200 and display the acquired image.

The current program schedule and the past program schedule described above are called by a touch operation or a voice input operation performed by a user. In the following, an operation of calling a current program schedule and a past program schedule will be briefly described.

In the embodiment, on the lower portion of the display screen, the display controller 132 is configured to be able to display the menu bar illustrated in FIG. 8. On the menu bar illustrated in FIG. 8, five keys (buttons) 801 to 805 are displayed. The key 801 is a key that is used to start up a current program schedule that is the list of TV programs that are currently being broadcast. Namely, by pressing the key 801 by a touch operation, a user can display the current program schedule illustrated in FIG. 5 or FIG. 6 on the display module 102.

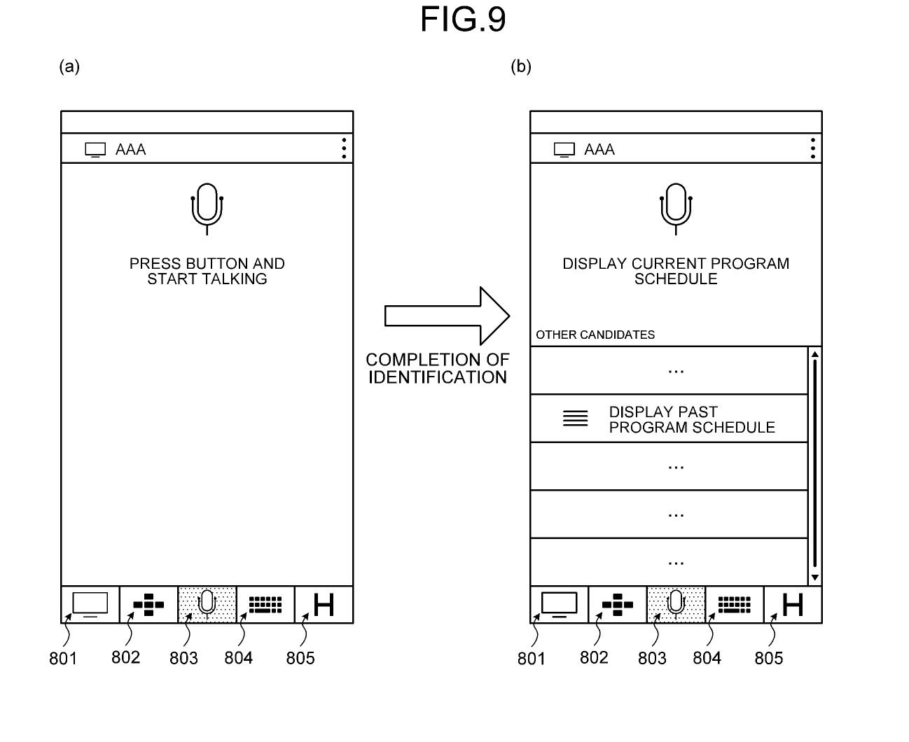

The key 802 is a key that is used to start up a remote controller detailed screen. By pressing the key 802 by a touch operation, a user can display a screen (not illustrated) that is used to operate the digital television device 200 on the display module 102. The key 803 is a key that is used to start up the voice input screen illustrated in FIG. 9. The voice input screen mentioned here is a screen that is used to input a voice instruction that is received from a user and that is to be performed on the mobile terminal 100.

When the key 803 is pressed by a user, the display controller 132 displays, on the display module 102, the screen illustrated in (a) of FIG. 9. Then, if the user performs a voice input while pressing the key 803 displayed on the screen illustrated in (a) of FIG. 9, the display controller 132 displays, on the display module 102 in accordance with the voice input performed by the user, the screen illustrated in (b) of FIG. 9.

The screen illustrated in (b) of FIG. 9 indicates that a voice input of “display the current program schedule” indicating a desire to display the current program schedule has been performed by a user on the screen illustrated in (a) of FIG. 9. If an operation to define the voice input of “display a current program schedule” is performed by the user on the screen illustrated in (b) of FIG. 9, the display controller 132 displays, on the display module 102, the current program schedule illustrated in FIG. 5 or FIG. 6.

Furthermore, on the screen illustrated in (b) of FIG. 9, a character string indicating “display the past program schedule” is also displayed as another candidate. If a user performs an operation of selecting the character string indicating “display the past program schedule” on the screen illustrated in (b) of FIG. 9 and an operation of defining the character string, the display controller 132 displays the past program schedule illustrated in FIG. 7 on the display module 102. Furthermore, the past program schedule is also displayed when a voice input of “display the past program schedule” performed by the user on the screen illustrated in (a) of FIG. 9 is defined.

In the following, keys other than the keys 801 to 803 will be described. The key 804 is a key that is used to start up a text input screen. The key 805 is a key that is used to start up a Hybridcast (registered trademark) cooperation function.

By referring back to FIG. 3, an example of the configuration of the digital television device 200 will be described. As illustrated in FIG. 3, the digital television device 200 comprises a controller 231, a display processor 232, a communication I/F 233, a command analyzer 234, a video recording manager 235, recorded data 236, a display module 237, and a past program schedule 238.

The controller 231 implements the video recording/playback function by controlling each component of the digital television device 200. The display module 237 is a display device. The display processor 232 is configured to control an input/output of the display module 237. The communication I/F 233 is configured to control communication with the mobile terminal 100 or the TV program server 300, the broadcast station server 400 (see FIG. 1), and the like on the Internet.

The command analyzer 234 is configured to analyze, various instructions (commands) received from the mobile terminal 100 via the communication I/F 233. An example of such a command includes an instruction to send, for example, when the past program schedule (see FIG. 7) is displayed on the display module 102 in the mobile terminal 100, the past program schedule 238 that is sent from the mobile terminal 100 to the digital television device 200.

The video recording manager 235 manages the recorded data 236 and the past program schedule 238 stored in a storage medium, such as an HDD, or the like. For example, after a command is analyzed by the command analyzer 234, if it is determined, on the result of the analysis, that the instruction to send the past program schedule 238 has been sent from the mobile terminal 100 to the digital television device 200, the video recording manager 235 reads the past program schedule 238 specified by that command.

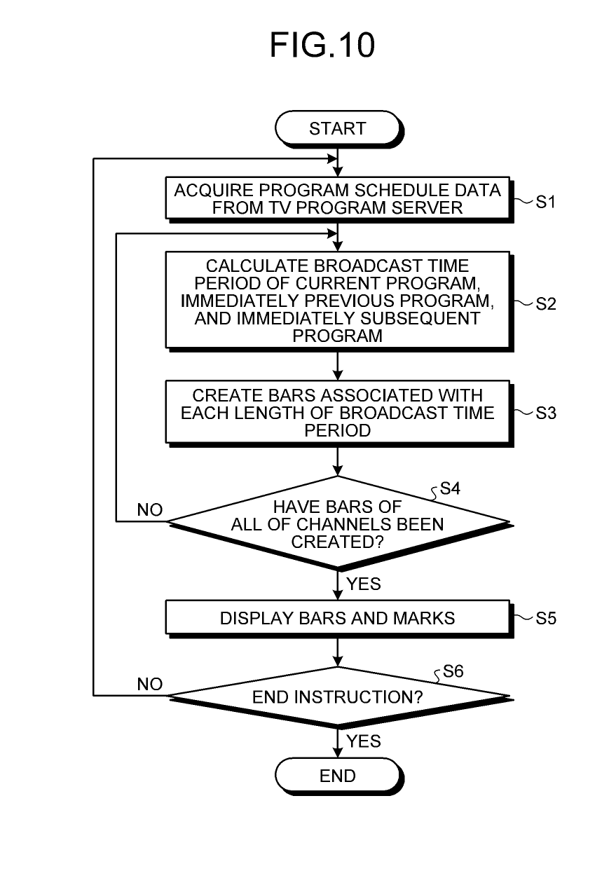

In the following, a description will be given, with reference to FIG. 10, of an example of the processing performed by the CPU 116 when the current program schedule (see FIG. 5 or FIG. 6) is displayed on the display module 102 in the mobile terminal 100 according to the embodiment.

In the processing flow of FIG. 10, first, as illustrated in FIG. 10, at S1, the processing of acquiring program schedule data (metadata associated with the current program schedule) related to a plurality of predetermined channels from the TV program server 300 is performed. And the processing proceeds to S2.

At S2, based on the program schedule data acquired at S1, the processing of calculating a broadcast time period of each of the current program that is currently being broadcast, the immediately previous TV program that was broadcast immediately before the current program, and the immediately subsequent TV program to be broadcast immediately after the current program is performed. And then the processing proceeds to S3.

Then, at S3, the processing of creating bars (bars B1 to B3 illustrated in FIGS. 5 and 6) corresponding to the length of each of the broadcast time periods calculated at S2 is performed. And then the processing proceeds to S4.

Then, at S4, the processing of determining whether bars of all of the channels have been created due to repetition of S2 and S3 is performed. At S4, if it is determined that bars of all of the channels have not been created, the processing returns to S2. Furthermore, at S4, if it is determined that bars of all of the channels have been created, the processing proceeds to S5.

Then, at S5, the processing of displaying, on the display module 102, the bars of all of the channels created by repetition of S2 and S3 together with the marks (the scales M1 illustrated in FIG. 5 and the marks M4 illustrated in FIG. 6) indicating the current time is performed. Consequently, the current program schedule illustrated in FIG. 5 or FIG. 6 is displayed on the display module 102. Here, the bars and the marks are displayed within the length corresponding to the time period between the first time that is a predetermined time before the reference time and the second time that is the predetermined time after the reference time. The reference time is the time corresponding to each of the scales M1 illustrated in FIGS. 5 and 6; the first time is the time corresponding to each of the scales M2 illustrated in FIGS. 5 and 6; and the second time is the time corresponding to each of the scales M3 illustrated in FIGS. 5 and 6. And then the processing proceeds to S6.

At S6, the processing of determining whether an end instruction to end a display of the current program schedule displayed on the display module 102 at S5 has been performed by a user is performed. At S6, if it is determined that the end instruction has been performed by the user, the processing is ended. In contrast, at S6, if it is determined that the end instruction has not been performed by the user, the processing returns to S1. Consequently, because the processing at S1 to S5 are repeatedly performed until the end instruction has been performed by the user, in the current program schedule illustrated in FIGS. 5 and the 6, in accordance with a change in current time, the display positions of the bars B1 to B3, the time displayed in the lower portion of each of the scales M1 to M3, the display positions of the marks M4 (only in the case illustrated in FIG. 6) that indicate the current time, or the like are changed.

Meanwhile, the processing flow performed when the past program schedule is displayed on the display module 102 is substantially the same as that illustrated in FIG. 10 except that the acquisition source of the program schedule data is not the TV program server 300 but is the digital television device 200; therefore, a description thereof will be omitted.

As described above, in the embodiment, the display controller 132 is configured to display the bars (bars B1 to B3 illustrated in FIGS. 5 and 6) and the marks (the scales M1 illustrated in FIG. 5 and the marks M4 illustrated in FIG. 6) on the display module 102 based on the program schedule data acquired from the TV program server 300 or the like. The bars have the length corresponding to each of the broadcast time period of a broadcast program, and the marks indicate the current time and is provided on this bar. With this configuration, by looking at the bars and the mark displayed on the display module 102, it is possible to easily and visually the relationship between the broadcast start time and the broadcast end time of each of the broadcast programs and the current time.

Furthermore, in the embodiment, the display controller 132 is configured to display the bars and the marks on the display module 102 for each channel registered in metadata corresponding to the program schedule data. Namely, if two broadcast programs belonging to different channels are assumed to be a first broadcast program and a second broadcast program, respectively, the display controller 132 is configured to display, on the display screen in the display module 102, a combination of the first bar and the first mark corresponding to the first broadcast program and the second bar and a combination of the second mark corresponding to the second broadcast program. Furthermore, the display controller 132 is configured to display, when the first broadcast time period of the first broadcast program is different from the second broadcast time period of the second broadcast program, the first bar and the second bar on the display module 102 such that the first length of the first bar is different from the second length of the second bar. Consequently, it is possible to easily and visually the relationship between the broadcast start time and the broadcast end time of each of the broadcast programs broadcast on each channel and the current time.

The mobile terminal (electronic device) 100 according to the embodiment has a hardware configuration using a typical computer and the program executed by the CPU 116 in the mobile terminal 100 is stored in the nonvolatile memory 120 formed of a ROM, a RAM, or the like. Then, this program is provided as a computer program product having a non-transitory computer readable recording medium, such as a CD-ROM, a flexible disk (FD), a CD-R, a digital versatile disk (DVD), or the like. The program is served as a file with the format that can be installed on the computer or that can be executed by the computer. Meanwhile, the program may be configured to be stored in a computer connected to a network, such as the Internet or the like, and be provided or delivered via the network. Furthermore, the program described above may also be configured to be provided in a state of being embedded in a ROM or the like in advance.

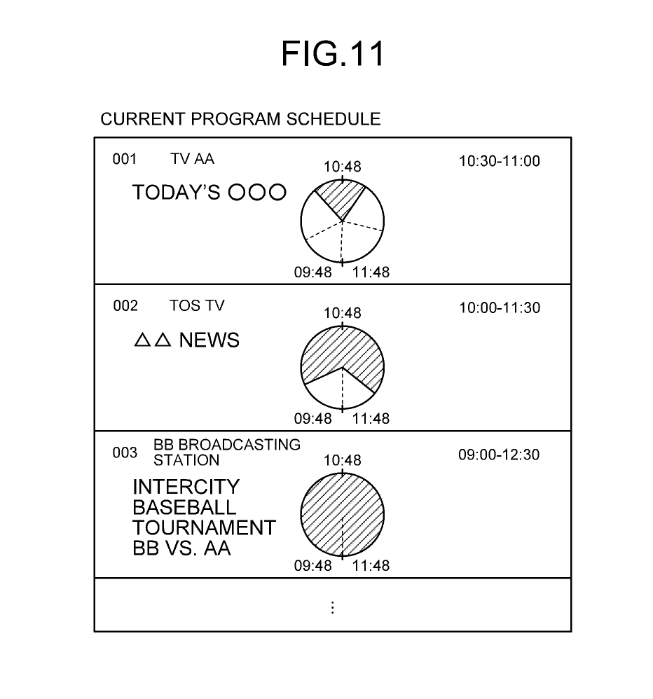

In the embodiment described above, a description has been given of an example in which the broadcast time periods of broadcast programs are recognized by a user using the bars displayed on the straight lines each of which has scales; however, as another embodiment, as the modification illustrated in FIG. 11, the broadcast time periods of the broadcast programs may also be recognized by a user by using circle graphs. In the current program schedule illustrated in FIG. 11, the area having a fan shape (or a circle shape) with oblique-line hatching indicated by the solid line represents the current program and the area having a fan shape without hatching indicated by the dotted line represents the immediately previous TV program and the immediately subsequent TV program. With the current program schedule illustrated in FIG. 11, by viewing the magnitude of the central angle, the length of an arc, and the size of the area of the fan shaped area, it is possible to check the broadcast time period of each of the TV programs.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method comprising:
accessing program information identifying a broadcast start time and a broadcast time period of each of a plurality of broadcast programs;
displaying a first bar of a first length and a first mark on a display based on the program information, the first length corresponding to a first broadcast time period of a first broadcast program, the first mark on the first bar identifying a current time;
displaying a second bar of a second length and a second mark on the display based on the program information, the second length corresponding to a second broadcast time period of a second broadcast program, the second mark on the second bar identifying the current time; and
displaying, when the first broadcast time period and the second broadcast time period are different from each other, the first bar and the second bar on the display such that the first length and the second length are different from each other.

2. The method of claim 1, wherein
each of the first bar and the second bar comprises a third bar, a fourth bar, and a fifth bar, the third bar corresponding to a current program being currently broadcast, the fourth bar corresponding to a previous program broadcast before the current program, the fifth bar corresponding to a subsequent program to be broadcast after the current program, and
the method further comprises displaying the fourth bar and the fifth bar in a different format than the third bar.

3. The method of claim 1, further comprising displaying the first bar, the first mark, the second bar, and the second mark within a first time period between a first time and a second time, the first time being earlier than a reference time by a second time period, the second time being later than the reference time by a third time period.

4. The method of claim 3, wherein the reference time is the current time or a particular time closest to the current time, the particular time one of a plurality of times defined at least in part by a particular time interval.

5. The method of claim 1, further comprising:
accessing the program information on a plurality of channels; and
displaying the first bar and the first mark of the first broadcast program for a first corresponding channel, and the second bar and the second mark for a second corresponding channel.

6. An electronic device comprising:
a program receiver configured to access program information identifying a broadcast start time and a broadcast time period of each of a plurality of broadcast programs; and
a display controller configured to display:
a first bar of a first length and a first mark on a display based on the program information, the first length corresponding to a first broadcast time period of a first broadcast program, the first mark on the first bar identifying a current time;
a second bar of a second length and a second mark on the display based on the program information, the second length corresponding to a second broadcast time period of a second broadcast program, the second mark on the second bar identifying the current time; and
when the first broadcast time period and the second broadcast time period are different from each other, the first bar and the second bar on the display such that the first length and the second length are different from each other.

7. The electronic device of claim 6, wherein
each of the first bar and the second bar comprises a third bar, a fourth bar, and a fifth bar, the third bar corresponding to a current program being currently broadcast, the fourth bar corresponding to a previous program broadcast before the current program, the fifth bar corresponding to a subsequent program to be broadcast after the current program, and
the display controller is further configured to display the fourth bar and the fifth bar in a different format than the third bar.

8. The electronic device of claim 6, wherein the display controller is further configured to display the first bar, the first mark, the second bar, and the second mark within a first time period between a first time and a second time, the first time being earlier than a reference time by a second time period, the second time being later than the reference time by a third time period.

9. The electronic device of claim 8, wherein the reference time is the current time or a particular time closest to the current time, the particular time one of a plurality of times defined at least in part by a particular time interval.

10. The electronic device of claim 6, wherein
the program receiver is further configured to access the program information on a plurality of channels, and
the display controller is further configured to display the first bar and the first mark of the first broadcast program for a first corresponding channel, and the second bar and the second mark of the second broadcast program for a second corresponding channel.

11. A computer program product having a non-transitory computer readable medium including programmed instructions, wherein the instructions, when executed by a computer, cause the computer to perform:
accessing program information identifying a broadcast start time and a broadcast time period of each of a plurality of broadcast programs;
displaying a first bar of a first length and a first mark on a display based on the program information, the first length corresponding to a first broadcast time period of a first broadcast program, the first mark on the first bar identifying a current time;
displaying a second bar of a second length and a second mark on the display based on the program information, the second length corresponding to a second broadcast time period of a second broadcast program, the second mark on the second bar identifying the current time; and
displaying, when the first broadcast time period and the second broadcast time period are different from each other, the first bar and the second bar on the display such that the first length and the second length are different from each other.

12. The computer program product of claim 11, wherein
each of the first bar and the second bar comprises a third bar, a fourth bar, and a fifth bar, the third bar corresponding to a current program being currently broadcast, the fourth bar corresponding to a previous program broadcast before the current program, the fifth bar corresponding to a subsequent program to be broadcast after the current program, and
the instructions cause the computer to further perform displaying the fourth bar and the fifth bar in a different format than the third bar.

13. The computer program product of claim 11, wherein the instructions cause the computer to further perform displaying the first bar, the first mark, the second bar, and the second mark within a first time period between a first time and a second time, the first time being earlier than a reference time by a second time period, the second time being later than the reference time by the third time period.

14. The computer program product of claim 13, wherein the reference time is the current time or a particular time closest to the current time, the particular time one of a plurality of times defined at least in part by a particular time interval.

15. The computer program product of claim 11, wherein the instructions cause the computer to further perform:
accessing the program information on a plurality of channels; and
displaying the first bar and the first mark of the first broadcast program for a first corresponding channel, and the second bar and the second mark for a second corresponding channel of the second broadcast program.
